(19) United States
(12) Patent Application Publication
(10) Pub. No.: US 2025/0131081 A1
(43) Pub. Date: Apr. 24, 2025

(54) ROOT OF TRUST CHAIN AND UPDATABLE SECURITY FOR PROGRAMABLE LOGIC DEVICES, SYSTEMS, AND METHODS

(71) Applicant: Lattice Semiconductor Corporation, Hillsboro, OR (US)

(72) Inventors: Srirama Chandra, Portland, OR (US); Mamta Gupta, Fremont, CA (US); Eric Sivertson, Reno, NV (US)

(21) Appl. No.: 18/916,352

(22) Filed: Oct. 15, 2024

Related U.S. Application Data
(60) Provisional application No. 63/591,415, filed on Oct. 18, 2023.

(51) Int. Cl. G06F 21/44

(52) U.S. Cl. CPC G06F 21/44

(57) ABSTRACT

Various techniques are provided for providing a root of trust chain, updating security protocols, and generating trusted customer configuration bitstreams for a programmable logic device (PLD). In one example, a method includes configuring hardware components of a PLD with an inherently trusted default set of operations immutably stored in a non-volatile memory and comprising a first root of trust for the PLD. The method also includes authenticating, by the hardware components configured with the default set of operations, a customer configuration bitstream comprising an updated set of operations. The method also includes reconfiguring the hardware components to replace the default set of operations with the updated set of operations if the authenticating is successful, wherein the updated set of operations comprise a second root of trust for the PLD. Additional devices, systems and methods are also provided.

### CROSS REFERENCE TO RELATED APPLICATIONS

This application claims priority to and the benefit of U.S. Provisional Patent Application No. 63/591,415 filed Oct. 18, 2023, and entitled “ROOT OF TRUST CHAIN AND UPDATABLE SECURITY FOR PROGRAMABLE LOGIC DEVICES, SYSTEMS, AND METHODS,” which is incorporated herein by reference in its entirety.

### TECHNICAL FIELD

This disclosure relates generally to programmable logic devices and, more specifically, to root of trust chains and security protocols for programmable logic devices.

### BACKGROUND

Programmable logic devices (PLDs), such as field programmable gate arrays (FPGAs), complex programmable logic devices (CPLDs), field programmable systems on a chip (FPSCs), or other types of programmable devices may be configured with various designs to implement desired functionality. The designs may be converted into synthesized components that are assigned to physical hardware components of the PLD configured to implement the designs. For example, configuration bitstreams may be stored in a memory and loaded (e.g., programmed) into appropriate hardware components to configure the PLD to implement a design.

PLD customers often dedicate considerable resources to developing designs for PLDs. As a result, protecting the associated configuration bitstreams and also protecting against subversion of desired operations or capability of the PLDs are important considerations for many PLD customers. As a result, PLDs may be implemented with security protocols to encrypt the configuration bitstreams and prevent unauthorized changes.

However, in conventional PLDs, security protocols may be implemented by microcontrollers with operations determined by non-upgradable read only memory (ROM) and/or other fixed hardware. As a result, upgrading the security protocols of conventional PLDs may be difficult or impossible after the PLDs have been provided to a customer. This is a particular concern if previously implemented security protocols are deemed insufficient in the future, for example, due to advances in quantum computing.

### SUMMARY

Various techniques are provided for providing a root of trust chain for a PLD employing various configuration bitstreams. For example, in an embodiment, a method includes configuring hardware components of a PLD with an inherently trusted default set of operations immutably stored in a non-volatile memory and comprising a first root of trust for the PLD; authenticating, by the hardware components configured with the default set of operations, a customer configuration bitstream comprising an updated set of operations; and reconfiguring the hardware components to replace the default set of operations with the updated set of operations if the authenticating is successful, wherein the updated set of operations comprise a second root of trust for the PLD.

Additional techniques are provided for updating security protocols of a PLD. For example, in an embodiment, a method includes configuring hardware components of a PLD with an inherently trusted default set of operations immutably stored in a non-volatile memory and comprising a first root of trust for the PLD; further configuring the hardware components with an inherently trusted default set of security protocols stored in the non-volatile memory; authenticating, by the hardware components configured with the default set of operations, an updated set of security protocols for the PLD; and replacing the default set of security protocols with the updated set of security protocols in the non-volatile memory if the authenticating of the updated set of security protocols is successful.

Further techniques are provided for generating trusted customer configuration bitstreams for a PLD. For example, in an embodiment, a method includes receiving a design for a programmable logic device (PLD); adding a trusted security block to the design; and generating a customer configuration bitstream for configuring hardware components of the PLD according to the design, wherein the customer configuration bitstream comprises: an updated set of operations to replace an inherently trusted default set of operations immutably stored in a non-volatile memory and comprising a first root of trust for the PLD, and the trusted security block to authenticate the customer configuration bitstream.

Additional embodiments directed to PLDs, devices, systems, and other methods are also disclosed.

### BRIEF DESCRIPTION OF THE DRAWINGS

FIG. 1 illustrates a block diagram of a PLD, a memory, an external system, and a trusted device in accordance with an embodiment of the disclosure.

FIG. 2 illustrates a block diagram of a non-volatile memory in accordance with an embodiment of the disclosure.

FIG. 3 illustrates a block diagram of configurable hardware components of a PLD in accordance with an embodiment of the disclosure.

FIG. 4 illustrates a process of populating a non-volatile memory in accordance with an embodiment of the disclosure.

FIG. 5 illustrates a process of generating a customer configuration bitstream in accordance with an embodiment of the disclosure.

FIG. 6 illustrates a process of operating a PLD in accordance with an embodiment of the disclosure.

FIG. 7 illustrates a process of authenticating a customer configuration bitstream in accordance with an embodiment of the disclosure.

FIG. 8 illustrates a process of updating security protocols in accordance with an embodiment of the disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

Various techniques are disclosed for providing a root of trust chain, updating security protocols, and generating trusted customer configurations for a PLD (e.g., implemented as customer configuration bitstreams or otherwise).

The PLD may be in communication with a non-volatile memory (e.g., on a separate die from the PLD in the same microchip, on the same die as the PLD, on a separate microchip from the PLD, and/or otherwise implemented). The non-volatile memory stores various configuration bitstreams, security protocols, metadata, data, and/or other information that may be accessed by the PLD under various circumstances.

The non-volatile memory may include a root of trust image (RTI) for the PLD that is immutably stored in the non-volatile memory, for example, an inherently trusted party (e.g., a manufacturer, customer, nation state, and/or other inherently trusted entity). The RTI may be an inherently trusted default configuration for hardware components of the PLD and therefore may be used to configure the hardware components without requiring authentication before each use. For example, the default configuration provided by the RTI may comprise a plurality of default operations to be performed by the hardware components when configured by the default configuration in response to a cold boot (e.g., power on reset) of the PLD and/or a reconfiguration performed in response to an appropriate trigger.

The non-volatile memory may include a root of trust image extension (RTIE) that identifies default security protocols used by the PLD for encrypting and/or decrypting: customer configuration bitstreams of the PLD; data stored, transmitted, and/or received by the PLD and/or the non-volatile memory; and/or other purposes as appropriate. Similar to the RTI, the RTIE may also be an inherently trusted default configuration for hardware components of the PLD and therefore may be used to configure the hardware components without requiring authentication before each use. Significantly, the RTIE may be replaced in the non-volatile memory (e.g., upgraded in the field) with an updated RTIE having updated security protocols in a manner that permits the PLD to operate with improved security protocols even after the PLD has been deployed. As a result, the PLD may be easily adapted to use improved security protocols in the event that the original RTIE security protocols become obsolete, compromised, and/or less effective (e.g., due to advances in quantum computing and/or otherwise).

The non-volatile memory may include one or more customer configuration bitstreams that may be authenticated and used to configure the hardware components of the PLD in place of the RTI default configuration. For example, a customer configuration bitstream may be provided with a trusted security block that, when detected by the PLD configured with the RTI default configuration, permits the PLD to trust the customer configuration bitstream. For example, in some embodiments, the trusted security block may restrict access to the non-volatile memory by the hardware components configured by the customer configuration bitstream. As a result, the customer configuration bitstream may provide a second root of trust in a root of trust chain with the first root of trust provided by the RTI default configuration.

In some embodiments, a previously authenticated customer configuration bitstream may be identified as such by metadata stored by the non-volatile memory. As a result, the PLD may not be required to reauthenticate the customer configuration bitstream if the metadata identifies that it has been previously authenticated. In some embodiments, if the RTIE security protocols have been updated, a previously authenticated customer configuration bitstream may be required to be reauthenticated before use (e.g., the customer configuration bitstream may not be encrypted with and/or otherwise compatible with the updated RTIE security protocols).

In addition, because the customer configuration bitstream includes the trusted security block, the PLD configured with the customer configuration bitstream may authenticate another customer configuration bitstream without relying on the RTI default configuration (e.g., the PLD is not required to reconfigure with the RTI default configuration to authenticate another customer configuration bitstream while configured with a current customer configuration bitstream). Thus, a root of trust chain may be provided by the RTI default configuration and extended to a plurality of customer configuration bitstreams.

In addition, the various customer configuration bitstreams may be used with the RTIE or updated RTIE (e.g., even after the RTI default configuration has been replaced by the customer configuration bitstream). As a result, the RTI default configuration and the RTIE security protocols may be replaced independently from each other and the customer configuration bitstream may be used with current or future security protocols.

The non-volatile memory may include various additional data and metadata as further discussed herein.

In some embodiments, customer configuration bitstreams may be generated by an external device or system separate from the PLD and operable to add the trusted security block to the customer configuration bitstream (e.g., stored in a resulting customer configuration bitstream used to configure the hardware components of the PLD with operations to implement a customer design and also with the trusted security block). In some embodiments, an additional device or system separate from the PLD and the generating device or system may independently detect the presence of the trusted security block in the customer configuration bitstream and therefore verify that the customer configuration bitstream includes a minimum level of security (e.g., to prevent PLD hardware components configured with the customer configuration bitstream from directly accessing the non-volatile memory and thereby preventing such hardware components from subverting desired operations or capabilities of the PLD through unauthorized changes to the various information stored in the non-volatile memory).

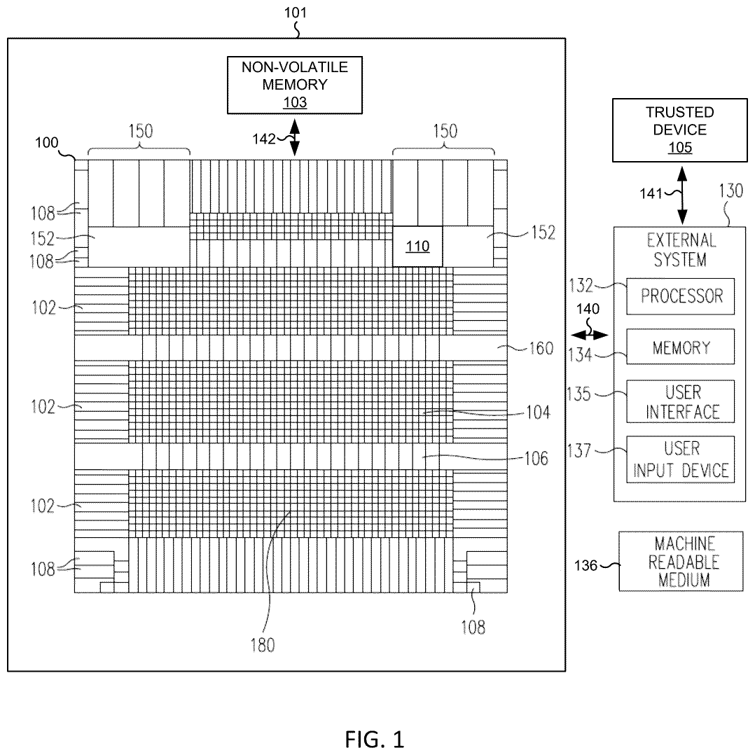

Referring now to the drawings, FIG. 1 illustrates a block diagram of a PLD 100, a non-volatile memory 103, an external system 130, and a trusted device 105 in accordance with an embodiment of the disclosure.

In the illustrated embodiment, PLD 100 and non-volatile memory 103 are implemented on separate dies provided within the same microchip 101. Other embodiments are also contemplated, such as the implementation of PLD 100 and non-volatile memory 103 on the same die together, on separate dies and separate microchips, and/or other implementations as discussed.

PLD 100 (e.g., a field programmable gate array (FPGA)), a complex programmable logic device (CPLD), a field programmable system on a chip (FPSC), or other type of programmable device) generally includes various physical hardware components (also referred to as configurable hardware components) such as input/output (I/O) blocks 102, logic blocks 104 (e.g., also referred to as programmable logic blocks (PLBs), programmable functional units (PFUs), or programmable logic cells (PLCs)) and others as discussed that may be configured in accordance with various combinations of RTI configurations, RTIE configurations, and/or customer configuration bitstreams stored in non-volatile memory 103 and further discussed herein.

I/O blocks 102 provide I/O functionality (e.g., to support one or more I/O and/or memory interface standards) for PLD 100, while logic blocks 104 provide logic functionality (e.g., look-up table (LUT) logic or logic gate array-based logic) for PLD 100. Additional I/O functionality may be provided by serializer/deserializer (SERDES) blocks 150 and physical coding sublayer (PCS) blocks 152. In various embodiments, I/O blocks 102 and SERDES blocks 150 may route signals to and from associated external ports (e.g., physical pins) of PLD 100. PLD 100 may also include hard intellectual property core (IP) blocks 160 to provide additional functionality (e.g., substantially predetermined functionality provided in hardware that may be configured with less programming than logic blocks 104).

PLD 100 may also include memory blocks 106 (e.g., blocks of EEPROM memory blocks, RAM (e.g., static and/or dynamic) memory blocks, and/or flash memory blocks), clock-related circuitry 108 (e.g., clock sources, PLL circuits, and/or DLL circuits), and/or various routing resources 180 (e.g., interconnect and appropriate switching logic to provide paths for routing signals throughout PLD 100, such as for clock signals, data signals, or others) as appropriate. In various embodiments, routing resources 180 may include user configurable routing resources and hardwired signal paths. In general, the various physical hardware components of PLD 100 may be used to perform their intended functions for desired applications, as would be understood by one skilled in the art.

For example, I/O blocks 102 may be used for programming PLD 100, such as memory blocks 106 (e.g., including volatile configuration memory) or transferring information (e.g., various types of data and/or control signals) to/from PLD 100 through various external ports as would be understood by one skilled in the art. I/O blocks 102 may provide a first programming port (which may represent a central processing unit (CPU) port, a peripheral data port, a serial peripheral interface (SPI), and/or a sysCONFIG programming port) and/or a second programming port such as a joint test action group (JTAG) port (e.g., by employing standards such as Institute of Electrical and Electronics Engineers (IEEE) 1149.1 or 1532 standards). I/O blocks 102 typically, for example, may be included to receive configuration bitstreams (e.g., over connection 142) to configure PLD 100 for its intended use and to support serial or parallel device configuration and information transfer with SERDES blocks 150, PCS blocks 152, hard IP blocks 160, and/or logic blocks 104 as appropriate.

For example, in some embodiments any of the various components discussed herein may be configured in response to a PLD 100 (e.g., implemented by appropriate logic such as one or more processors, finite state machines, and/or other hardware and/or software) passing RTI configurations, RTIE configurations, customer configuration bitstreams, and/or other data (e.g., any of which may be stored in non-volatile memory 103 and/or elsewhere as appropriate) by routing resources 180. In some embodiments, configurations and/or data may be stored by non-volatile memory 103, locally on PLD 100 (e.g., in one or more memory blocks 106) and/or stored externally from PLD 100 (e.g., in a memory 134 of an external system 130).

It should be understood that the number and placement of the various components are not limiting and may depend upon the desired application. For example, various components may not be required for a desired application or design specification (e.g., for the type of programmable device selected).

Furthermore, it should be understood that the components are illustrated in block form for clarity and that various components would typically be distributed throughout PLD 100, such as in and between logic blocks 104, hard IP blocks 160, and routing resources 180 to perform their conventional functions (e.g., storing configurations that configure PLD 100 or providing interconnect structure within PLD 100). It should also be understood that the various embodiments disclosed herein are not limited to programmable logic devices, such as PLD 100, and may be applied to various other types of programmable devices, as would be understood by one skilled in the art.

Non-volatile memory 103 (e.g., a flash memory and/or any other desired type of non-volatile memory) may store various RTI configurations, RTIE configurations, customer configuration bitstreams, and/or other data for reading from, writing to, and/or configuring hardware components of PLD 100 as further discussed herein. Non-volatile memory 103 may communicate with PLD 100 through connection 142 which may be implemented in any appropriate manner. For example, in some embodiments, connection 142 may be an SPI connection (e.g., actual or emulated) in communication with I/O blocks 102.

Although non-volatile memory 103 is illustrated in communication with PLD 100 through connection 142, other connections are contemplated. For example, in some embodiments, non-volatile memory 103 may communicate directly with external system 130, trusted device 105, and/or other systems or devices as appropriate.

System 130 (e.g., also referred to as an external device) may be used to generate a desired customer configuration bitstream of PLD 100 in accordance with a customer design. As further discussed herein, system 130 may add a trusted security block to the customer configuration bitstream to provide a minimum level of security for the customer configuration bitstream. Such configurations may be stored in non-volatile memory 103 and/or elsewhere as appropriate and used by PLD 100 to configure various hardware components of PLD 100.

In the illustrated embodiment, system 130 is implemented as a computer system. In this regard, system 130 includes, for example, one or more processors 132 (e.g., implemented by appropriate logic as discussed with regard to PLD 100) which may be configured to execute instructions, such as software instructions, provided in one or more memories 134 and/or stored in non-transitory form in one or more non-transitory machine-readable mediums 136 (e.g., a memory or other appropriate storage medium internal or external to system 130). For example, in some embodiments, system 130 may run a PLD configuration application, such as Lattice Radiant software available from Lattice Semiconductor Corporation to permit a user (e.g., a customer or manufacturer) to create a desired configuration and generate a corresponding configuration bitstream to program PLD 100.

System 130 also includes, for example, a user interface 135 (e.g., a screen or display) to display information to a user, and one or more user input devices 137 (e.g., a keyboard, mouse, trackball, touchscreen, and/or other device) to receive user commands or design entry to prepare a desired configuration of PLD 100. As shown, system 130 may communicate with PLD 100 over a connection 140.

In some embodiments, system 130 may be a test bed operated by a predetermined inherently trusted party (e.g., a manufacturer, a customer, a nation state, and/or other trusted party) to generate and/or store RTI configurations, RTIE configurations, and/or other configurations and data in non-volatile memory 103 (e.g., during manufacture of microchip 101).

Trusted device 105 (e.g., also referred to as a trusted system) is separate from microchip 101 and system 130 (e.g., but may be in communication therewith in some embodiments) and is operable to independently detect the presence of the trusted security block in the customer configuration bitstream generated by system 130 and therefore verify that the customer configuration bitstream includes a minimum level of security as discussed. Trusted device 105 may be implemented with any of the various components of system 130 discussed herein to provide such features. Trusted device 105 may communicate with system 130 over a connection 141 (e.g., to receive customer configuration bitstreams for verification).

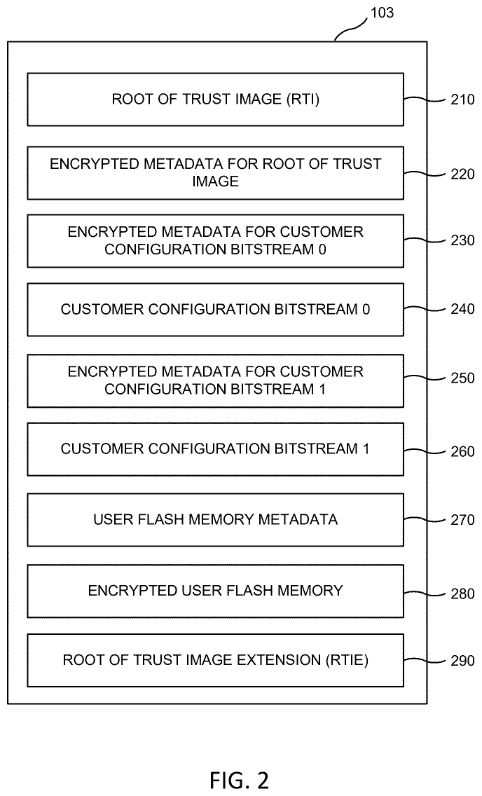

FIG. 2 illustrates a block diagram of non-volatile memory 103 in accordance with an embodiment of the disclosure. As discussed, non-volatile memory 103 stores various information that may be used to configure PLD 100 and/or facilitate its operation in accordance with various default configurations, customer configuration bitstreams, and security protocols. The various configurations (e.g., configuration bitstreams) stored in non-volatile memory 103 may be loaded (e.g. programmed) into configurable hardware components (e.g., by configuration engine 110) of PLD 100 to configure or reconfigure such hardware components as discussed herein.

RTI 210 is an inherently trusted default configuration for hardware components of PLD 100 that does not require authentication before each use. RTI 210 may be immutably stored in non-volatile memory 103 (e.g., addresses of non-volatile memory 103 that store RTI 210 may be disabled from being written to by PLD 100) by a manufacturer or other inherently trusted party. RTI 210 may be a configuration bitstream that may comprise a plurality of default operations to be performed by the configurable hardware components of PLD 100 in response to a power on reset (e.g., a cold boot and/or a reconfiguration performed in response to an appropriate trigger) of PLD 100.

RTIE 290 is an inherently trusted set of security protocols used by PLD 100 that do not require authentication before each use. RTIE 290 may be provided by a manufacturer or other inherently trusted party. RTIE 290 may provide security protocols for encrypting and/or decrypting: customer configuration bitstreams of the PLD; data stored, transmitted, and/or received by the PLD and/or the non-volatile memory; and/or other purposes as appropriate. RTIE 290 may be replaced (e.g., upgraded in the field) with an updated RTIE having updated security protocols in a manner that permits PLD 100 to operate with improved security protocols even after PLD 100 has been deployed to a customer.

Metadata 220 is encrypted metadata used by RTI 210, such as cryptographic keys used by various security protocols implemented by RTIE 290 and also an identification of whether PLD 100 should be further configured with RTIE 290 during operation.

Customer configuration bitstream 240 (e.g., also referred to as customer configuration 0 or a first customer configuration bitstream) configures the hardware components of PLD 100 in place of RTI 210 or another customer configuration (e.g., customer configuration bitstream 260). For example, after PLD 100 is configured by RTI 210, customer configuration bitstream 240 may be authenticated (e.g., by the presence of a trusted security block and/or metadata 230 identifying a previous authentication as discussed) and loaded into PLD 100 to configure hardware components to implement a customer design. As discussed, customer configuration bitstream 240 may provide a second root of trust in a root of trust chain with the first root of trust provided by RTI 210. Metadata 230 is encrypted metadata used by customer configuration bitstream 240 and may identify whether customer configuration bitstream 240 has been previously authenticated as discussed.

Customer configuration bitstream 260 (e.g., also referred to as customer configuration 1 or a second customer configuration bitstream) configures the hardware components of PLD 100 in place of RTI 210 or another customer configuration (e.g., customer configuration bitstream 240). For example, after PLD 100 is configured by customer configuration bitstream 240, then customer configuration bitstream 260 may be authenticated (e.g., by the presence of a trusted security block and/or metadata 250 identifying a previous authentication as discussed) and loaded into PLD 100 to configure hardware components to implement a customer design. As discussed, customer configuration bitstream 260 may provide a third root of trust in a root of trust chain with the first root of trust provided by RTI 210 and the second root of trust provided by customer configuration bitstream 240. In another embodiment, the root of trust chain may include only RTI 210 and customer configuration bitstream 260. Metadata 250 is encrypted metadata used by customer configuration bitstream 260 and may identify whether customer configuration bitstream 260 has been previously authenticated as discussed.

Metadata 270 is additional metadata that may be populated by a customer and associated with customer configuration bitstream 240 and/or 260. User memory 280 is encrypted memory that may be populated by a user of PLD 100 and may be used by PLD 100 during runtime and/or otherwise as appropriate.

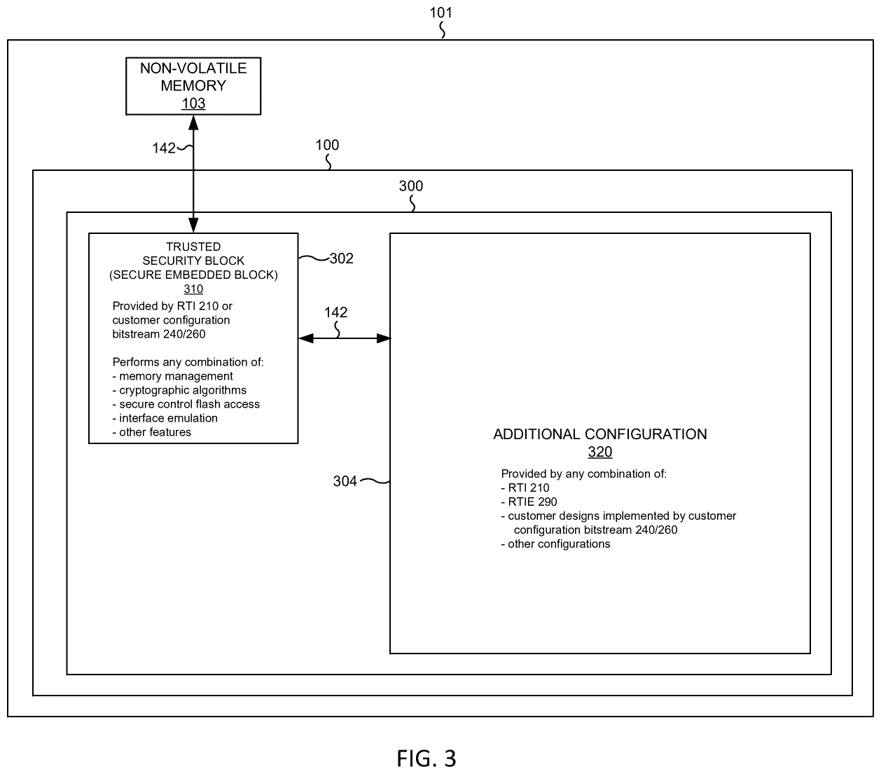

FIG. 3 illustrates a block diagram of configurable hardware components 300 of PLD 100 in accordance with an embodiment of the disclosure. As similarly illustrated with regard to FIG. 1, PLD 100 and non-volatile memory 103 may be implemented on separate dies provided in the same microchip 101 and may communicate over connection 142.

Hardware components 300 may include various physical hardware components such as I/O blocks 102, logic blocks 104, and others as discussed and may be configured in accordance with various combinations of RTI configurations, RTIE configurations, and/or customer configurations stored in non-volatile memory 103.

For example, a portion 302 of hardware components 300 may be configured with a trusted security block 310 that provides various security features to facilitate the interfacing of non-volatile memory 103 with hardware components 300 including but not limited to memory management, cryptographic algorithms, secure control flash access, and interface emulation (e.g., for SPI-based communications or otherwise). Another portion 304 of hardware components 300 may be configured with an additional configuration 320 that may include various combinations of RTI 210 configurations, RTIE 290 configurations, customer configuration bitstreams 240/260 (e.g., to implement customer designs), and/or other configurations stored in non-volatile memory 103 and loaded (e.g., programmed) into portion 302 of hardware components 300.

As shown, direct communication between hardware components 300 and non-volatile memory 103 is limited to trusted security block 310. Additional configuration 320 cannot communicate directly with non-volatile memory 103. Instead, communications between additional configuration 320 and non-volatile memory 103 are restricted (e.g., monitored, limited, and/or otherwise managed) by trusted security block 310 which provides a minimum level of security to prevent additional configuration 320 from directly accessing non-volatile memory 103 and thereby prevents additional configuration 320 from subverting desired operations or capabilities of PLD 100 through unauthorized changes to the various information stored in non-volatile memory 103).

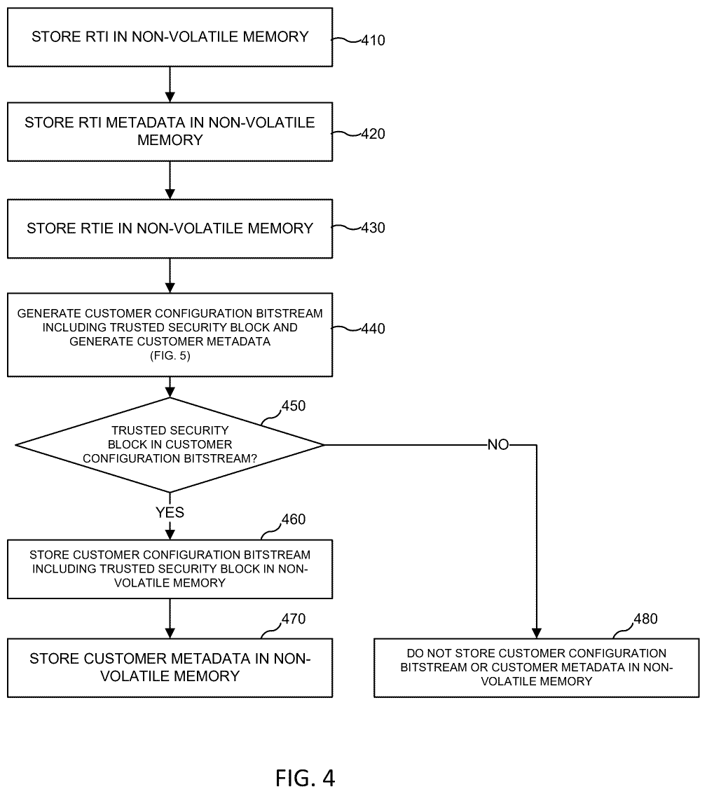

FIG. 4 illustrates a process of populating non-volatile memory 103 in accordance with an embodiment of the disclosure. In some embodiments, the process of FIG. 4 may be performed during the manufacturing and/or initial deployment of PLD 100.

In operation 410, RTI 210 is stored in non-volatile memory 103. As discussed, RTI 210 may be stored in an immutable manner by a manufacturer or other inherently trusted party (e.g., using a test bed provided by system 130 and/or other approaches) such that it cannot be erased, replaced, rewritten, and/or otherwise modified after being stored. As a result, RTI 210 is an inherently trusted default configuration for hardware components 300 of PLD 100 as discussed.

In operation 420, metadata 220 used by RTI 210 is stored in non-volatile memory 103, for example, by a manufacturer or other inherently trusted party using similar hardware as discussed for operation 410.

In operation 430, RTIE 290 is stored in non-volatile memory 103. In some embodiments, an original default RTIE 290 may be stored, for example, by a manufacturer or other inherently trusted party using similar hardware as discussed for operation 410. In some embodiments, an updated RTIE 290 may be stored in non-volatile memory 103 as further discussed herein.

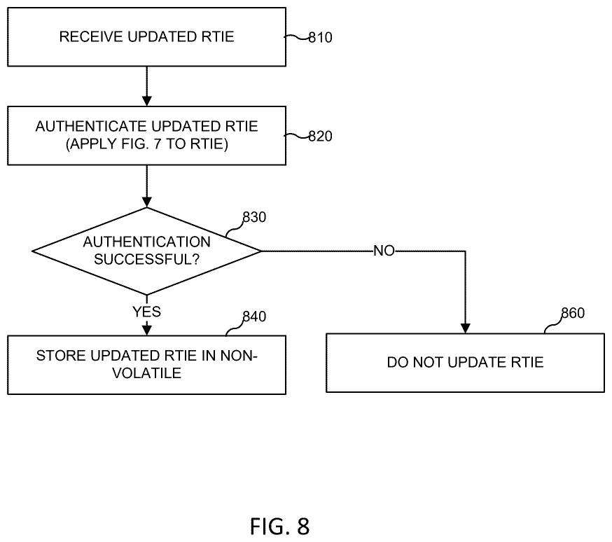

In some embodiments, operation 430 may not be performed during the initial populating process of FIG. 4. For example, in some cases, PLD 100 may be deployed without security protocols (e.g., depending on customer needs) and RTIE 290 may be populated at a later time (e.g., using a process of updating RTIE 290 as further discussed herein with regard to FIG. 8).

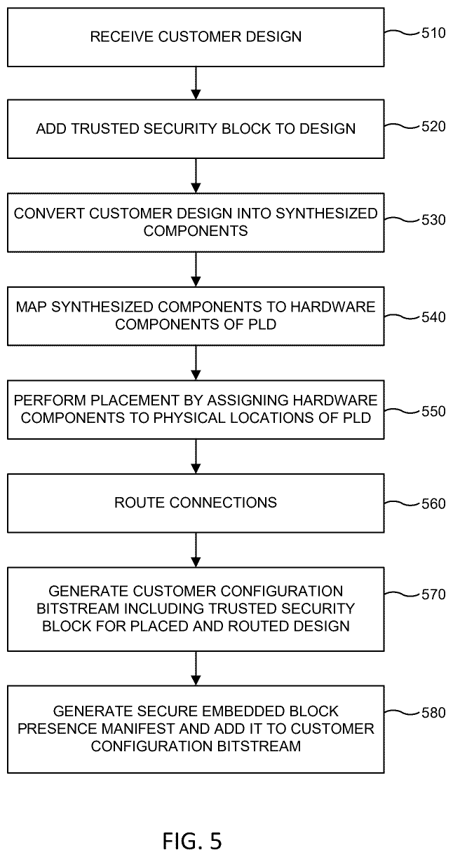

In operation 440, one or more of customer configuration bitstream 240/260 and/or customer metadata 230/250 are generated as further discussed with regard to the process of FIG. 5.

In operation 450, trusted device 105 reviews (e.g. parses) customer configuration bitstream 240/260 generated in operation 440 to confirm that trusted security block 310 is included. In some embodiments, trusted device 105 may decrypt customer configuration bitstream 240/260 with a security key (e.g., a cryptographic key) to identify such confirmation. If trusted security block 310 is included in customer configuration bitstream 240/260, then the process of FIG. 4 continues to block 460 where customer configuration bitstream 240/260 is stored in non-volatile memory 103, and on to operation 470 where customer metadata 230/250 is stored in non-volatile memory 103. If trusted security block 310 is not included in customer configuration bitstream 240/260, then the process of FIG. 4 continues to operation 480 where no customer configurations 240/260 or customer metadata 230/250 are stored in non-volatile memory 103.

In some embodiments, the process of FIG. 4 may include additional operations to store metadata 270 and information for user memory 280 as appropriate.

It will be appreciated that, following the completion of the process of FIG. 4, non-volatile memory 103 will be populated with RTI 210 and may be optionally further populated with RTIE 290, customer configuration bitstream 240, metadata 230, customer configuration bitstream 260, and/or metadata 250 as discussed. As a result, non-volatile memory 103 will be ready to be deployed with PLD 100 into a desired application. In addition, one or more of RTIE 290, customer configuration bitstream 240, metadata 230, customer configuration bitstream 260, and/or metadata 250 may be updated in the field after deployment as discussed herein.

FIG. 5 illustrates a process of generating customer configuration bitstream 240/260 for PLD 100 in accordance with an embodiment of the disclosure. As discussed, the process of FIG. 5 may be performed during operation 440 of FIG. 4. For example, the process of FIG. 5 may be performed by system 130 running a PLD configuration application such as Lattice Radiant Software as discussed. In some embodiments, the various files and information referenced in FIG. 5 may be stored, for example, in one or more databases and/or other data structures in memory 134, machine readable medium 136, non-volatile memory 103, and/or otherwise.

In operation 510, system 130 receives a design (e.g., a customer design) that specifies desired functionality of PLD 100. For example, a user (e.g., customer) may interact with system 130 (e.g., through user input device 137 and hardware description language (HDL) code representing the design) to identify various features of the design (e.g., operations to be performed by PLD 100 when configured and/or other features). In some embodiments, the design may be provided in a register transfer level (RTL) description (e.g., a gate level description). System 130 may perform one or more rule checks to confirm that the design describes a valid configuration of PLD 100. For example, system 130 may reject invalid configurations and/or request the user to provide new design information as appropriate.

In operation 520, system 130 adds trusted security block 310 to the design to provide such features to the resulting customer configuration bitstream as discussed.

In operation 530, system 130 synthesizes the design to convert the design (including both the customer design and the trusted security block 310) into a plurality of synthesized components (e.g., logical constructs representing operations performed by the design). For example, operation 530 may include converting the design into a netlist (e.g., a synthesized RTL description) identifying an implementation of the design as a plurality of synthesized components (e.g., also referred to as logic components or netlist components). In this regard, the synthesized components may identify logic, hardware functions, and/or other design features that may be subsequently mapped to various types of hardware components provided by PLD 100 discussed herein in operation 540. In some embodiments, the netlist may be stored in Verilog format in a Unified Database (UDB) file and/or Electronic Design Interchange Format (EDIF) in a Native Generic Database (NGD) file.

In some embodiments, operation 530 may include performing an optimization process on the design to reduce propagation delays, consumption of PLD resources and interconnections, and/or otherwise optimize the performance of PLD 100 when configured with the design. For example, the optimization process may be performed on the netlist representing the synthesized design to provide an improved netlist representing an improved synthesized design.

In operation 540, system 130 performs a mapping process that identifies various types of hardware components of PLD 100 that may be used to implement the synthesized components identified in operation 530.

In operation 550, system 130 performs a placement process to assign the types of hardware components mapped in operation 540 to the actual physical hardware components 300 residing at specific physical locations of PLD 100, and thus determine a layout for PLD 100. In some embodiments, the placement may be performed on one or more previously-stored UDB and/or NGD files, with the placement results stored as another physical design file.

In operation 560, system 130 performs a routing process to route connections (e.g., using routing resources 180) among the physical hardware components 300 of PLD 100 based on the placement layout determined in operation 550 to realize the physical interconnections among the placed components. In some embodiments, the routing may be performed on one or more previously-stored UDB and/or NGD files, with the routing results stored as another physical design file. Thus, following operation 560, one or more physical design files may be provided which specify the design after it has been synthesized (e.g., converted and optimized), mapped, placed, and routed for PLD 100 (e.g., by combining the results of the corresponding previous operations).

In operation 570, system 130 generates customer configuration bitstream 240/260 for the synthesized, mapped, placed, and routed design. For example, the generated customer configuration bitstream 240/260 may be a configuration bitstream compatible for storage in non-volatile memory 103 and configuring hardware components 300.

In operation 580, system 130 generates additional information in the form of a manifest that is added to customer configuration bitstream 240/260 to identify that the trusted security block 310 has been included in customer configuration bitstream 240/260.

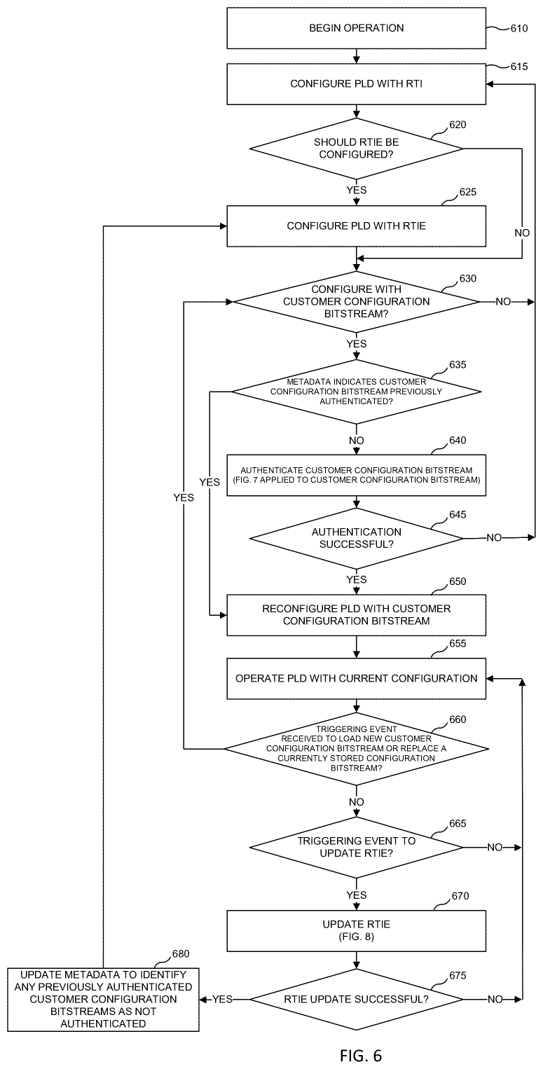

FIG. 6 illustrates a process of operating PLD 100 in accordance with an embodiment of the disclosure. In operation 610, PLD 100 begins operating, for example, in response to a cold boot (e.g., power on reset) and/or an appropriate trigger (e.g., a signal and/or command received from an external source and/or from a prior operation of PLD 100).

In operation 615, PLD 100 reads RTI 210 from non-volatile memory 103 and configures hardware components 300 in accordance with the default operations of RTI 210. For example, portion 302 may be configured with trusted security block 310 included in RTI 210, and portion 304 may be configured with the remainder of RTI 210.

In operation 620, PLD 100 determines whether hardware components 300 should be further configured with RTIE 290. For example, PLD 100 may determine whether RTIE 290 is present in non-volatile memory 103 and/or may read metadata 220 to make such determination. If yes, then the process of FIG. 6 continues to operation 625 where PLD 100 further configures portion 304 of hardware components 300 with RTIE 290 (e.g., portion 304 of hardware components 300 may be configured with both RTI 210 and RTIE 290 simultaneously). If no, portion 304 of hardware components 300 remains configured with only RTI 210 and the process of FIG. 6 continues to operation 630.

In operation 630, PLD 100 determines whether hardware components 300 should be reconfigured with a selected one of customer configuration bitstreams 240/260 in place of RTI 210. For example, PLD 100 may determine whether the selected customer configuration bitstream 240/260 is present in non-volatile memory 103. If yes, then the process of FIG. 6 continues to operation 635. If no, the process of FIG. 6 returns to operation 615.

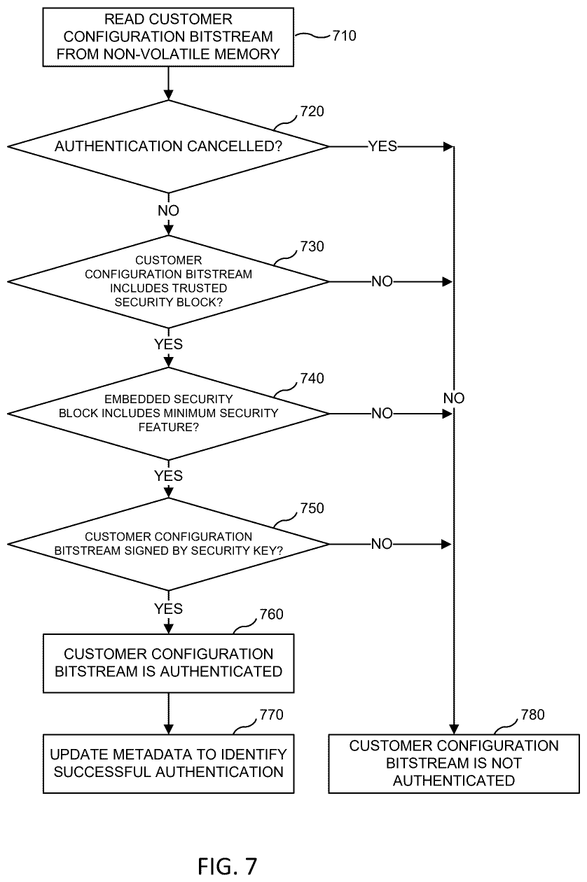

In operation 635, PLD 100 reads metadata 230/250 to determine whether the particular one of customer configuration bitstreams 240/260 selected in operation 630 was previously authenticated, for example, as a result of a previous performance of the process of FIG. 7. If no, then the process of FIG. 6 continues to operation 640. If yes, the process of FIG. 6 continues to operation 650.

In operation 640, PLD 100 performs the process of FIG. 7 to authenticate the selected customer configuration bitstream 240/260 as further discussed herein. In some embodiments, the selected customer configuration bitstream 240/260 may be decrypted for authentication using security keys stored in metadata 220. In operation 645, If the authentication is successful, then the process of FIG. 6 continues to operation 650. If the authentication is not successful, then the process of FIG. 6 returns to operation 615.

In operation 650, PLD 100 reconfigures hardware components 300 with customer configuration bitstream 240/260. In this regard, portion 302 is reconfigured with the trusted security block 310 included with the selected customer configuration bitstream 240/260 (e.g., the previous trusted security block 310 provided by RTI 210 or another previously loaded configuration bitstream is replaced with the trusted security block 310 included with customer configuration bitstream 240/260). In addition, portion 304 is reconfigured with the operations of the selected customer configuration bitstream 240/260 (e.g., the previous configuration provided by RTI 210 or another earlier configuration bitstream is replaced in portion 304 with customer configuration bitstream 240/260; portion 304 will continue to include RTIE 290 if previously so configured in operation 625).

In operation 655, PLD 100 operates hardware components 300 as reconfigured by customer configuration bitstream 240/260 and/or as previously configured by RTIE 290.

In operation 660, if a triggering event (e.g., a signal, command, and/or other trigger) to reconfigure hardware components 300 by loading or replacing the current configuration bitstream with a new customer configuration bitstream (e.g., reconfiguring hardware components 300 with customer configuration bitstream 240/260) is received, then the process of FIG. 6 returns to operation 630 to repeat operations 630 to 655 for the new or replacement customer configuration bitstream (e.g., if hardware components 300 were previously configured with customer configuration bitstream 240, they may be reconfigured with customer configuration bitstream 260, or vice versa). If no such triggering event is received, then the process of FIG. 6 continues to operation 665.

In operation 665, if a triggering event (e.g., a signal, command, and/or other trigger) to update RTIE 290 is received, then the process of FIG. 6 continues to operation 670. If no such triggering event is received, then the process of FIG. 6 returns to operation 655.

In operation 670, PLD 100 performs the process of FIG. 8 to update RTIE 290 as further discussed herein.

In operation 675, if the update to RTIE 290 is successful, then the process of FIG. 6 continues to operation 680. If the update to RTIE 290 is not successful, then the process of FIG. 6 returns to operation 655.

In operation 680, PLD 100 updates metadata 230/250 to identify that customer configuration bitstreams 240/260 are not authenticated. In this regard, although one or both of customer configuration bitstreams 240/260 may have been previously authenticated during a previous iteration of operation 640, operation 680 ensures that they will be reauthenticated before use after RTIE 290 has been successfully updated. In this regard, if the security protocols provided by RTIE 290 have been updated, then any previously authenticated customer configuration bitstreams 240/260 may not be encrypted with and/or otherwise compatible with the updated security protocols provided by RTIE 290. Updating metadata 230/250 in this manner ensures that a reauthentication is performed before PLD 100 is reconfigured with customer configuration bitstreams 240/260.

FIG. 7 illustrates a process of authenticating one of customer configuration bitstreams 240/260 selected in operation 630 (e.g., whichever one is currently being considered for possible reconfiguration of hardware components 300) in accordance with an embodiment of the disclosure. As discussed, the process of FIG. 7 may be performed during operation 640 of FIG. 6.

In operation 710, PLD 100 reads customer configuration bitstream 240/260 from non-volatile memory 103.

In operation 720, PLD 100 determines whether the authentication process of FIG. 7 has been cancelled (e.g., in response to a signal, command, and/or other trigger). If yes, then the process of FIG. 7 continues to operation 780 where customer configuration bitstream 240/260 is not authenticated and the associated metadata 230/250 remains unchanged. If no, then the process of FIG. 7 continues to operation 730.

In operation 730, PLD 100 determines whether customer configuration bitstream 240/260 includes trusted security block 310. For example, in some embodiments, PLD 100 may parse configuration bitstream 240/260 to determine whether it includes a manifest previously added by system 130 in previous operation 580. In some embodiments, PLD 100 may parse configuration bitstream 240/260 to detect the presence of trusted security block 310 in the bitstream itself. If trusted security block 310 is detected, then the process of FIG. 7 continues to operation 740. Otherwise, the process of FIG. 7 continues to operation 780.

In operation 740, PLD 100 determines whether the detected trusted security block 310 includes a minimum security feature. For example, in some embodiments, this may include restricting portion 304 of hardware components 300 from directly accessing non-volatile memory 103 as previously discussed and further illustrated in FIG. 3. In other embodiments, the entirety of the trusted security block 310 may be reviewed to determine whether all expected features of trusted security block 310 are present. If operation 740 is satisfied, then the process of FIG. 7 continues to operation 750. If not, the process of FIG. 7 continues to operation 780.

In operation 750, PLD 100 determines whether customer configuration bitstream 240/260 is signed by a security key (e.g., provided by trusted device 105 in operation 450. If yes, then the process of FIG. 7 continues to operation 760. If no, the process of FIG. 7 continues to operation 780.

In operation 760, customer configuration bitstream 240/260 is confirmed to be authenticated as a result of the successful completion of operations 730, 740, and 750. In some embodiments, such confirmation may be conditioned on greater or fewer authentication operations than those identified in FIG. 7.

In operation 770, PLD 100 updates metadata 230/250 to identify that the selected customer configuration bitstream 240/260 is authenticated.

FIG. 8 illustrates a process of updating security protocols for PLD 100 in accordance with an embodiment of the disclosure. As discussed, the process of FIG. 8 may be performed during operation 670 of FIG. 6.

In operation 810, PLD 100 receives an updated RTIE 290. For example, the updated RTIE 290 may be provided by a manufacturer, customer, and/or other trusted through system 130 over connection 140, any of the various I/O blocks 102 of PLD 100, and/or other appropriate techniques. As discussed, the updated RTIE 290 may include updated security protocols to replace the default security protocols included in the current RTIE 290 stored in non-volatile memory.

In operation 820, PLD 100 authenticates the updated RTIE 290. For example, in some embodiments, PLD 100 may apply the process of FIG. 7 to the updated RTIE 290 to detect the presence of trusted security block 310, the presence of a minimum security feature, a signature by a security key, and/or any other desired authentication technique.

In operation 830, if the authentication is successful, then the process of FIG. 8 continues to operation 840 where PLD 100 stores the updated RTIE 290 in non-volatile memory 103 to replace the current RTIE 290. If the authentication is not successful, then the process of FIG. 8 continues to operation 860 where the current RTIE 290 is not updated (e.g., not replaced with the updated RTIE 290 in non-volatile memory 103). Thus, it will be appreciated that PLD 100 may be subsequently reconfigured with the updated RTIE 290 without requiring further authentication at the time of such reconfiguration.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as program code and/or data, can be stored on one or more computer readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A method comprising:
configuring hardware components of a programmable logic device (PLD) with an inherently trusted default set of operations immutably stored in a non-volatile memory and comprising a first root of trust for the PLD;
authenticating, by the hardware components configured with the default set of operations, a customer configuration bitstream comprising an updated set of operations; and
reconfiguring the hardware components to replace the default set of operations with the updated set of operations if the authenticating is successful, wherein the updated set of operations comprise a second root of trust for the PLD.

2. The method of claim 1, wherein the authenticating comprises:
verifying the customer configuration bitstream comprises a trusted security block.

3. The method of claim 2, wherein:
the verifying comprises determining the customer configuration bitstream restricts access to the non-volatile memory by the hardware components.

4. The method of claim 1, wherein the authenticating comprises:
reading metadata associated with the customer configuration bitstream; and
confirming the metadata identifies that the customer configuration bitstream was previously authenticated.

5. The method of claim 1, wherein:
the customer configuration bitstream is a first customer configuration bitstream and the updated set of operations is a first updated set of operations; and
the method further comprises:
authenticating, by the hardware components configured with the first updated set of operations, a second customer configuration bitstream comprising
a second updated set of operations, and reconfiguring the hardware components with the second updated set of operations to replace the first updated set of operations in the hardware components, wherein the second updated set of operations comprise a third root of trust for the PLD.

6. The method of claim 1, the method further comprises:
further configuring the hardware components with an inherently trusted default set of security protocols stored in the non-volatile memory;
authenticating, by the hardware components configured with the default set of operations, an updated set of security protocols for the PLD; and
if the authenticating of the updated set of security protocols is successful:
replacing the default set of security protocols with the updated set of security protocols in the non-volatile memory, and
identifying the customer configuration bitstream as not authenticated.

7. The method of claim 6, further comprising:
reconfiguring the hardware components with the default set of operations;
further configuring the hardware components with the updated set of security protocols; and
reauthenticating, by the hardware components reconfigured with the default set of operations, the customer configuration bitstream.

8. The method of claim 6, wherein:
the default set of operations and the default set of security protocols are provided by a predetermined inherently trusted party; and
the default set of security protocols and the updated set of security protocols comprise cryptographic processes.

9. A PLD comprising a field programmable gate array (FPGA) operable to perform the method of claim 1.

10. A method comprising:
configuring hardware components of a programmable logic device (PLD) with an inherently trusted default set of operations immutably stored in a non-volatile memory and comprising a first root of trust for the PLD;
further configuring the hardware components with an inherently trusted default set of security protocols stored in the non-volatile memory;
authenticating, by the hardware components configured with the default set of operations, an updated set of security protocols for the PLD; and
replacing the default set of security protocols with the updated set of security protocols in the non-volatile memory if the authenticating of the updated set of security protocols is successful.

11. The method of claim 10, further comprising:
identifying a customer configuration bitstream comprising an updated set of operations as not authenticated if the authenticating of the updated set of security protocols is successful.

12. The method of claim 10, further comprising:
authenticating, by the hardware components configured with the default set of operations, a customer configuration bitstream comprising an updated set of operations; and
reconfiguring the hardware components to replace the default set of operations with the updated set of operations if the authenticating of the customer configuration bitstream is successful, wherein the updated set of operations comprise a second root of trust for the PLD.

13. The method of claim 12, wherein the authenticating the customer configuration bitstream comprises:
verifying the customer configuration bitstream comprises a trusted security block.

14. The method of claim 13, wherein:
the verifying comprises determining the customer configuration bitstream restricts access to the non-volatile memory by the hardware components.

15. The method of claim 12, wherein the authenticating the customer configuration bitstream comprises:
reading metadata associated with the customer configuration bitstream; and
confirming the metadata identifies that the customer configuration bitstream was previously authenticated.

16. The method of claim 12, wherein:
the customer configuration bitstream is a first customer configuration bitstream and the updated set of operations is a first updated set of operations; and
the method further comprises:
authenticating, by the hardware components configured with the first updated set of operations, a second customer configuration bitstream comprising a second updated set of operations, and
reconfiguring the hardware components with the second updated set of operations to replace the first updated set of operations in the hardware components, wherein the second updated set of operations comprise a third root of trust for the PLD.

17. The method of claim 10, wherein:
the default set of operations and the default set of security protocols are provided by a predetermined inherently trusted party; and
the default set of security protocols and the updated set of security protocols comprise cryptographic processes.

18. A PLD comprising a field programmable gate array (FPGA) operable to perform the method of claim 10.

19. A method comprising:
receiving a design for a programmable logic device (PLD);
adding a trusted security block to the design; and
generating a customer configuration bitstream for configuring hardware components of the PLD according to the design, wherein the customer configuration bitstream comprises:
an updated set of operations to replace an inherently trusted default set of operations immutably stored in a non-volatile memory and comprising a first root of trust for the PLD, and
the trusted security block to authenticate the customer configuration bitstream.

20. The method of claim 19, wherein:
the receiving, the adding, and the generating are performed by a first device different from the PLD; and
the method further comprises verifying, by a second device different from the first device and the PLD, that the customer configuration bitstream comprises the trusted security block.
